(19) United States
(12) Patent Application Publication
(10) Pub. No.: US 2006/0048162 A1
(43) Pub. Date: Mar. 2, 2006

(54) Method for implementing a multiprocessor message queue without use of mutex gate objects

(75) Inventor: Stefan R. Boult, Phoenix, AZ (US)

Correspondence Address: Dr. Russell W. Guenthner;Bull HN Information Systems Inc., 13430 North Black Canyon Highway, Phoenix, AZ, 85029, US

(73) Assignee: Bull HN Information Systems Inc.

(21) Appl. No.: 10/928,542

(22) Filed: Aug. 26, 2004

(51) Int. Cl. G06F 9/46

(52) U.S. Cl. 719/310

(57) ABSTRACT

A reliable and performant mechanism for communicating between independent processes, threads or parts of a computer system is described in which conditional atomic counters are used to manage a message queue. The conditional atomic counters control access to a message queue or memory space in a simple and reliable manner while minimizing the overhead of access to the mutex gate objects typically used in the implementation of message queues of the prior art. When implemented in software, a producer count and consumer count are maintained using conditional atomic store instructions with the condition on the store ensuring that one and only one producer or consumer of message records can actually post or receive validation of any specific message record. A counterpart implementation in hardware utilizes hardware mechanisms equivalent to those invoked by the software program.

### FIELD OF THE INVENTION

This invention relates to the arts of computer programming, operating system design, computer program threads and thread design, inter-process and inter-processor communications, logic design, computer system design, and, more particularly, to a method for communicating, typically using message queues, between independent elements such as threads, processes or parts of a computer system in which a reliable and efficient method is needed for communicating between multiple independent elements of a computer system with those elements potentially running and accessing the memory of a message queue simultaneously.

### BACKGROUND OF THE INVENTION

In the arts of computer programming, operating system design, the design of computer programs utilizing threads, inter-process and inter-processor communications, logic design, and computer system design, there is need for a method of efficient memory to memory communication between independent elements of a computer system. This communication is often implemented using queues of messages contained in a common memory space. The method of communication should provide for messages to be sent reliably and with as little interference as possible with or between other elements that may also be sending or receiving messages. Typically the avoidance of interference between processes or processors is achieved by using objects in computer memory space called mutexes to serve as gates to control access to a common memory area. This technique is well known in the art of computer systems design or programming.

In the reference manual “The Free On-line Dictionary of Computing” by Denis Howe provided on the web site “www.dictionary.com” the word “mutex” is described as follows:
MUTEX—“A mutual exclusion object that allows multiple threads to synchronize access to a shared resource. A mutex has two states: locked and unlocked. Once a mutex has been locked by a thread, other threads attempting to lock it will block. When the locking thread unlocks (releases) the mutex, one of the blocked threads will acquire (lock) it and proceed. If multiple threads or tasks are blocked on a locked mutex object, the one to take it and proceed when it becomes available is determined by some type of scheduling algorithm. For example, in a priority based system, the highest priority blocked task will acquire the mutex and proceed. Another common set-up is [to] put blocked tasks on a first-in-first-out queue.”

Mutexes are typically implemented utilizing a word in the computer system's memory as a flag word and then requiring all elements of the computer system needing access to another area of memory that is associated with that specific mutex flag word to interrogate the flag word and access the associated memory only when the flag word is in some proper state. The requesting computer elements make access to the flag word in a manner that ensures only one element will receive access to the associated memory space at any one instant in time. As an example of the mechanism for mutexes, the GCOS8 operating system from Bull HN utilizes a hardware instruction called “Load A and Clear” (LDAC opcode mnemonic) that, as a single atomic operation, reads a word from memory into the “A” register, sets indicator bits indicating whether the word was previously zero or negative, and then clears the word in memory to zero before any other processor or process is allowed to make subsequent access to that memory location. There are similar instructions in most computer systems designed for running in a multi-processor environment.

Using flag words to implement a mutex object often creates a system performance problem because the mutex word itself becomes a critical resource of the system. This is a consequence of the mutex word being very frequently interrogated by many elements of the system and as a result the controlled modification of the mutex gate becomes a bottleneck that limits the system's overall performance.

It is the purpose of this invention to provide a method of implementing communication between elements of a computer system which does not require execution of code based on conditional examination of a highly contentious mutex gate word and which instead utilizes an alternative method of access control which can be much more efficient in both its software or hardware implementation. Instead of a mutex gate word, the method of this invention utilizes two counters or pointers that are located within the computer system's memory space, and the computer system must provide a method of conditionally and atomically incrementing each of these two counters upon direction by any one of the processing elements. The word “atomic” in this instance describes an operation in which the reading of the data in the word, the addition of an incremental value to form a new value for that word and the storing of that new value back into the same location in the computer system's memory is all done as one “atomic”, that is, one unbroken or one uninterruptible operation. This means that if two elements of the computer system attempt to increment the same counter simultaneously it must be guaranteed by the system or system hardware that each element will achieve a single increment and the element that has done the increment will receive in return to it as the incremented value a number different than the value any other incrementing element will receive. That is, if two elements do an increment, the counter will be incremented exactly twice. This is typically accomplished by the computer system hardware with a single instruction designed for such purpose. The key concept is the atomicity of the increment; that is, when the computer hardware or central processing unit reads the specified memory location holding the counter, it must increment and store back into the memory location the new incremented value before relinquishing the control of the block of memory containing that memory location to any other processing unit.

It is also required that the atomic increment of the counter be controlled so that only one requesting process will increment the counter when simultaneous, or nearly simultaneous requests for an increment are made and the queue is nearly full or nearly empty. For purposes of this invention this “conditional” feature is used to maintain tight control near boundary conditions where the message queue is full or nearly full and also when the message queue has almost zero entries in the queue. For this reason the increment cannot be done with an instruction that simply increments memory; it must be done with a conditional exchange that writes a new value into memory only if the value already in memory has not changed since it was previously read and used for checking the queue size. An example of such an instruction is the “Store A Conditional on Q” (STACQ) of the Bull HN DPS 9000 series computer system. When this instruction is executed the hardware compares the memory operand with the contents of the “Q” register. If the value from memory is equivalent to the contents of the “Q” register, then the contents of the “A” register is stored into that same memory location and the zero indicator is set ON; if the value from memory is NOT equivalent to the contents of the “Q” register, then the memory contents are left unchanged the zero indicator is set OFF.

Since the conditional storing of a single word in memory with a single instruction is typically fast and efficient and cannot be delayed indefinitely by the actions of any other process or processor, and also significantly in this invention the incrementing of the word itself provides for either reserving the memory space for the sending of a message, or signaling that a message has been taken, then these together result in a very efficient method of communication with high bandwidth and with reduced levels of interference between the elements of the system compared to methods of the prior art which utilize mutex gate words and for which the update or checkout delay may sometimes be indefinite or complex in analysis.

For further clarification as an example for the conditional increment of the producer count 220 from an exemplary numeric value of “4” to a new value of “5”, the value of the counter would first be read and found to be “4”. The value of “4” would be used to check the size of the message queue. If there was room remaining in the queue, a conditional store instruction would be performed with the condition register loaded with a “4”, and the register holding the new value to be stored into the memory location loaded with a “5”. The conditional store instruction would then atomically set the memory location holding the producer count to a “5” if and only if the current value in that same memory location were a “4”. This is a conditional atomic increment of the producer count from “4” to “5”. The conditional store instruction would also provide indication in the indicator registers as to whether the store was successfully completed.

### OBJECTS OF THE INVENTION

It is therefore a broad object of this invention to provide a method for sending messages between multiple elements of a computer system by providing a message queue or queues in computer system memory with access to the message area in these queues controlled by an efficient mechanism utilizing counters and atomic operations upon these counters which are efficiently implemented by the computer system hardware or software. The result of such method provides better system performance than the approach of the prior art, with the approach of the prior art typically utilizing mutex gate objects for control of access to a message area in the computer system memory. The method also allows for multiple elements of the computer system to be simultaneously writing into different message areas.

### SUMMARY OF THE INVENTION

Briefly, these and other objects of the invention are achieved by providing a message queue or queues each indexed and controlled for access by two counters, an input counter and an output counter utilizing a method that ensures that messages can be entered at any time (within limits of memory space) and that the mechanism provides a subsidiary memory space which is guaranteed by the method to not be in simultaneous use by another computing element and in which the message can be written without any further checking. The method does not utilize mutex gate words in the computer system memory to control access to the memory space. The changing (incrementing) of the counter words is performed utilizing either computer system hardware or a software procedure that ensures that the incrementing is done as a conditional atomic or uninterruptible single operation. The result of such method provides better system performance than the approach of the prior art. This better performance is achieved in the invention because the atomic incrementing of counter words can be more efficiently performed by either the computer system hardware or a software procedure than typical methods of the prior art which require repeated interrogation and capture of a mutex object before the posting of a message to the queue or the freeing of memory space following retrieval of a message from a queue.

### DESCRIPTION OF THE DRAWING

The subject matter of the invention is particularly pointed out and distinctly claimed in the concluding portion of the specification. The invention, however, both as to organization and method of operation, may best be understood by reference to the following description taken in conjunction with the subjoined claims and the accompanying drawing of which:

FIG. 1 is a diagram of a typical memory system organization depicting a message queue and controlling objects to administer the message queue;

FIG. 2 is a diagram showing the message id field within each record in the message queue. This message id field is used to provide an indicator for the consumer to not retrieve the rest of the message until after it can be guaranteed that the producer has completed writing the entire message into the queue;

FIG. 3 is a diagram depicting a typical procedure for atomically performing the conditional increment of a counter such as the producer counter or consumer counter;

FIG. 4 is a flow diagram depicting a typical procedure that would post a message in the queue;

FIG. 5 is a flow diagram that depicts a typical procedure that would consume a message from the queue.

### DESCRIPTION OF THE PREFERRED EMBODIMENT(S)

While an embodiment of the invention will be described below in a manner assuming that the mechanism of the invention is implemented using computer software as part of a computer program, those skilled in the art will recognize that the mechanism itself could be implemented completely in hardware and the invention is not limited to implementation only in software.

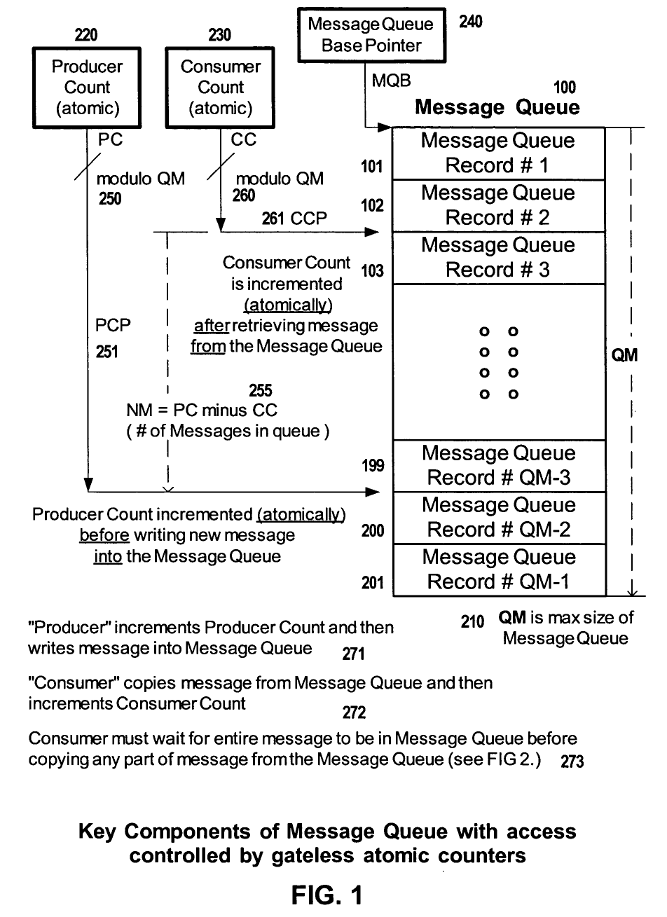

Referring first to FIG. 1, there is a message queue 100 which contains within it message queue records such as those shown as record #1, #2, #3 and #QM-3, #QM-2, and #QM-3 numbered in the drawing as 101, 102, 103, 199, 200, 201 respectively. The message queue 100 is a circular queue in that it has a maximum size which is the number QM 210 and after a record is written into location QM 210 in the message queue, the next message will be written into the first location in the message queue, that being record # 1 which is numbered 101 in the figure. The circular message queue 100 is accomplished by applying the modulo function to any pointer or counter which addresses the message queue 100 as shown by the modulo QM function marked as items 250 and 260 in the figure. Applying the modulo function as shown in figure items 250 and 260 to all addresses which are used to index into the message queue 100 makes the queue appear to be “circular” or continuous as long as the maximum number of messages held in the queue at any time is maintained to be no more than QM 210, which is defined as the maximum control limit on the number of messages to be held in the queue at any time.

In FIG. 1, the message queue 100 is addressed by two counters, one which is the count of incoming messages called the producer count 220, and a second which is a count of the messages taken from the queue called the consumer count 230. After applying the modulo functions 250 and 260 described above, these are transformed into actual offsets from the message queue base (MQB) 240 of the message queue 100 for the producer 250 and consumer count 260 which are marked as PCP 251 (producer count pointer) and CCP (consumer count pointer) 261 respectively. Thus the actual memory address for a message to be written into the message queue 100 is MQB 240 plus PCP 251 with the message written after the increment of the producer count 220 as described in the note 271 in FIG. 1. The actual memory address for a message to be read or taken from the message queue 100 is MQB 240 plus CCP 261 with the message copied out of the message queue before the increment of the consumer count 230.

Atomically incrementing the producer count 220 before the message is written into the message queue 100 guarantees that only one producer will be writing into any one message queue record. This is true because the atomic increment guarantees that every producer looking to post a new message will receive (be returned) a producer count that is different after the increment has been performed (when the increment succeeds).

As shown in FIG. 1 (note 272), copying the message out of the message queue 100 before atomically incrementing the consumer count 230 is required in order to guarantee that once the consumer count is incremented, the previous record (pointed to by the consumer count pointer before the increment) is instantly available for writing by any producer. That is, the data must be copied out of the message queue 100 before any subsequent producer frees that space for writing. Without this, the case where the next producer is quicker at writing new message data than the consumer is at reading the desired message data would be result in a timing hazard.

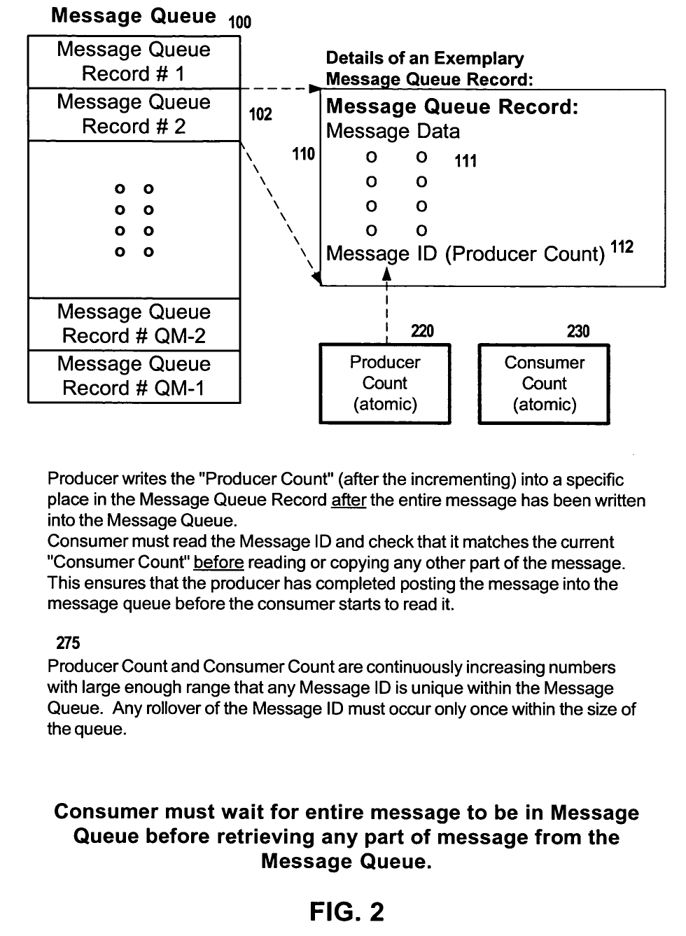

A second timing hazard is described briefly in note 273 of FIG. 1. Referring to FIG. 2, this second hazard is caused by the increment of the producer count 220 before the message to be delivered is written into the message queue 100. The increment of the producer count must be before the writing of the message because it is the return value from the atomic increment itself that in effect allocates that memory to that specific producer. It is not possible to write the data into the message record before the atomic increment of the producer count, because if that were allowed any producer could be trying to write into the same memory record or memory space. Delaying the writing of the message until after the atomic increment of the produce count 220 means that immediately following the increment there is a finite period of time during which the producer count is pointing to a message queue record which is not yet or not yet completely written. During this time that message queue record could hold old or partially written data and so a potential consumer must not retrieve (read) that data immediately even though the consumer mechanism by looking at only the producer count would consider the message to be ready.

To prevent this second hazard, the potential consumer must wait for a condition that signals when the entire message in a specific message queue record is complete, and this condition must be examined before the message is copied from the message queue. Referring again to FIG. 2, an exemplary method of accomplishing this is to write into the message queue record 110 a message-id field 112 which is the value of the producer count 220 (before the modulo function) and make that message-id not only a part of the message, but also to make it the final word of the message that is written. That is, the message-id must be sent to memory “last” (last in time) when the message data 111 of the entire message record is written. The consumer who has just incremented the consumer count can then check that the consumer count 230 (after the increment, but before the modulo function 260) matches the message-id 112 which is the producer count in the message queue record and if that condition is not true, to then wait until the writing of the entire message including the message data 111 and the message-id 112 is complete and it becomes true. This must be a finite amount of time because the producer is required to copy the message in an expeditious manner (that is, immediately) once the producer count is incremented. If the message id field is not found valid, that is, it is found to not match the consumer count, after some delay, it will be assumed that the producer has failed to deliver the message in due time, and the message will be discarded by the consumer with proper notification and recovery. At that time, nothing in the discarded message record would be considered valid. The producer count and consumer count start at the same value and refer to the same message queue, so comparing the consumer count to the message-id before retrieving the rest of the data in the message record will guarantee that the entire record is valid in memory before the data is copied or retrieved.

A further note 275 in FIG. 2 describes the assumption of the algorithm that the size of the registers, that is the number of bits in a register, used to store the producer count 220 and consumer count 230 must be larger than needed to describe only the size of the message queue. The producer count and consumer count registers must be wide enough that they do not themselves wraparound and allow the same legal value to appear more than once within the message queue.

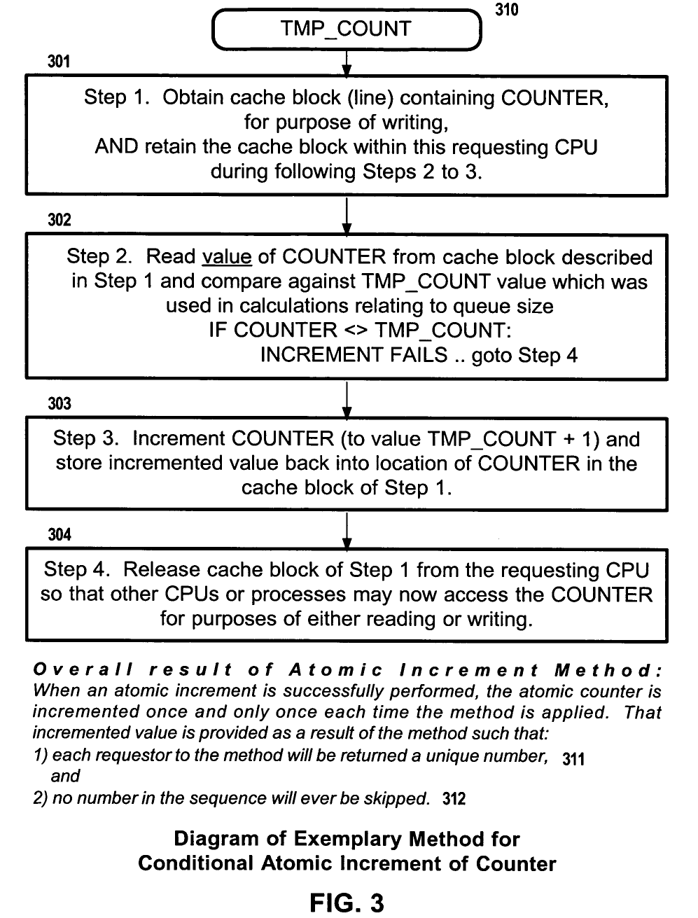

Referring next to FIG. 3 an exemplary method for providing a conditional atomic increment of a counter such as the producer count or consumer count is shown. The overall expectation of an atomic increment is described in FIG. 3 marked as items 311 and 312. Atomic increment means that even though several processes or tasks may be attempting to increment a counter in memory at the same time, each of these processes will accomplish that task one and only one time per request, and that as the increment occurs each process will receive in return from the method of atomic increment either a value which is unique 311 and such that no number in the sequence will ever be skipped 312, or a rejection of failure of the increment signaling that another producer or consumer has already performed that increment.

A method of atomic increment that meets these requirements is shown as Steps 1 through 5 in FIG. 3 marked as items 301, 302, 303, and 304. Step 1 301 is the start of the method which is to first bring into the cache of the CPU processing the requesting process the cache block or word containing the counter. The block is brought into the CPU cache for the purpose of writing, meaning that other caches in the system may be notified to clear the block from their caches, so that the requesting CPU solely owns the block. The block is then retained in the requesting CPU's cache until the completion of Steps 2 through 4 described hereafter. Step 2 302 proceeds to read the value of the counter from the cache into a register inside the CPU, to compare that number with the value of TMP_COUNT 310 that was provided by the process proposing the increment. (Referring back to NM 255 from FIG. 1, TMP_COUNT 310 was the producer count number used in calculating the size of the message queue). Again in FIG. 3, step 3 303 is to add one to the value just read (which is the same as TMP_COUNT plus 1) and to immediately store that back into the cache in the same location from which it had retrieved the incremented value. Step 4 304 is to release the block or word containing the counter from its state of holding and allow normal cache action on that block to continue, including potentially moving the block to other processors. It can be seen that this method prevents other processes from gaining access to the word during the process of incrementing so that the two requirements of the atomic increment 311, 312 are achieved.

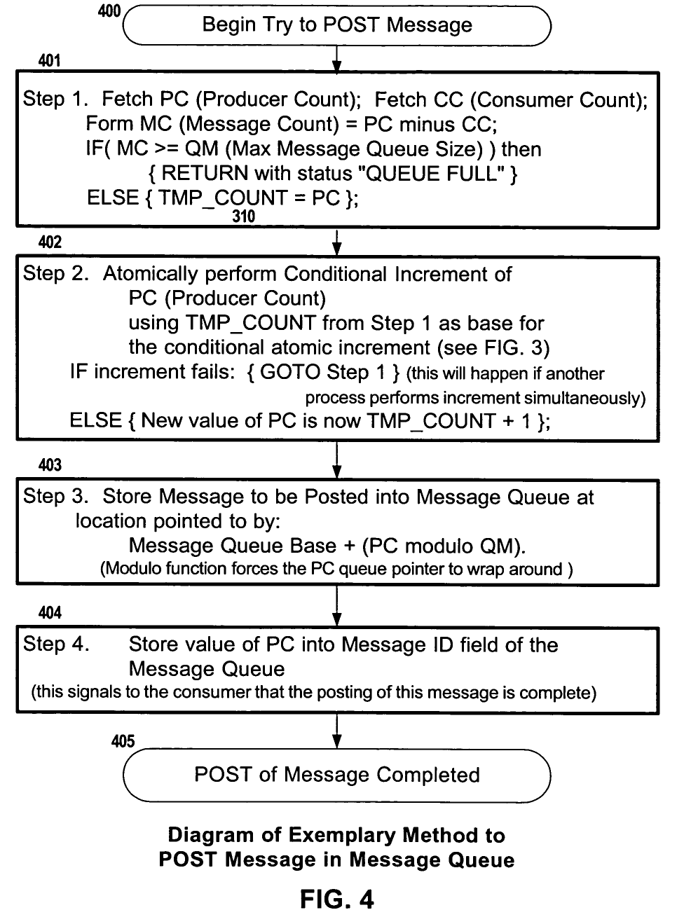

FIG. 4 is a diagram of an exemplary method for the “posting” of a message in the message queue. The posting of a message is a process performed by a producer of messages. Either this or any other producer of messages must write each message posted into memory in a place that is not in conflict with other messages. The messages must be recorded in a manner such that a consumer or several consumers of messages can retrieve messages one at a time and also such that all messages can be retrieved and no messages are skipped or lost. A producer of a message will begin 400 a try to post a message by invoking a method, which can be divided into three steps. Step 1 401 is to first determine if there is room in the message queue 100 as shown in FIG. 1 to add a new message. Making this decision requires fetching the value of the producer count 220 and consumer count 230 from memory, calculating the difference by subtracting the producer count from the consumer count, and comparing this difference NM 255 with QM 210 which is the maximum size of the message queue 100. If there is room, the current value of the producer count is saved as the value TMP_COUNT 310, and the process proceeds to Step 2 402; if there is no room in the message queue 100 for another message, then the producer is notified that the message queue is full, and the posting must wait until room is made available by the processes which are consumers of messages. In Step 2 402 the producer count 220 is atomically incremented to be one more than the value of TMP_COUNT saved from Step 1 401, and the value of the counter after the increment is returned to the requesting producer. Step 2 402 can also fail in the “compare exchange” in the case where another producer had already achieved in performing the increment.

Referring briefly again referring to FIG. 1, the producer count pointer PCP 251 which is the pointer to the memory location to be used for writing of the message by the producer can be calculated by summing the pointer to the base of the message queue 240 with the modulo QM of the producer count 250. This modulo function 250 forces the message queue to “wrap around” or be viewed as circular, even though the producer count and consumer counts 220 and 230 continue to increment to values greater than the maximum size QM 210 of the message queue.

Step 3 of FIG. 4 is performed by the producer of the message, and that is to write the message data as shown in FIG. 2 into the area pointed to by producer count pointer 251 and then as a final action to write the value of the producer count itself for the message record just written into the message record itself as a message-id 112. This final action signals to the consumer of the message that the message is complete in the message queue and ready for retrieval. During the period of time where the message-id 112 is not yet written by the producer, the memory location which will eventually hold the final message-id would hold an “old” message-id that would not match the consumer count of the consuming process. The post of the message is then complete 405.

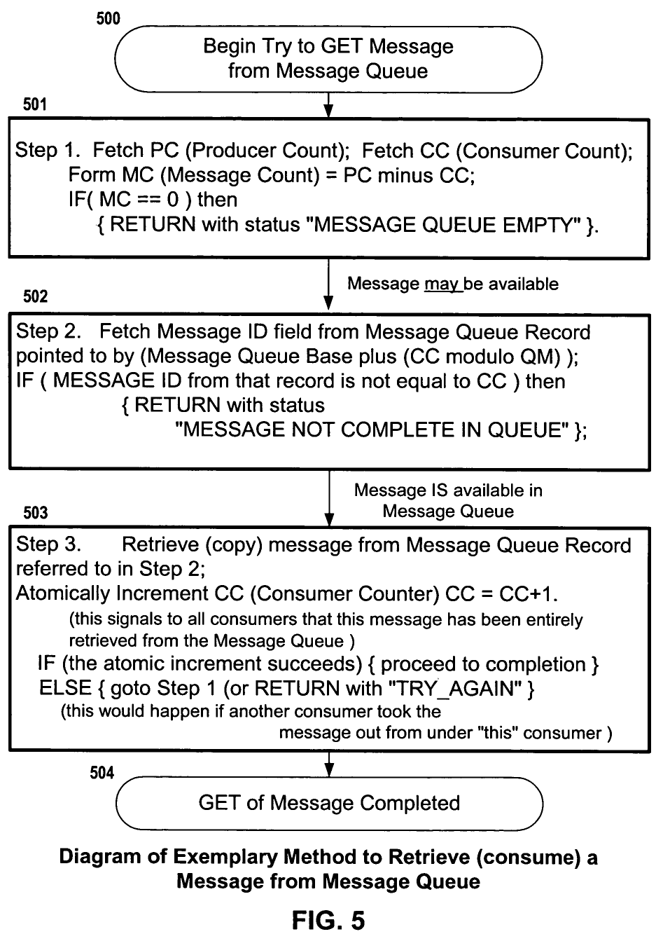

The process of consuming a message is shown in FIG. 5. The process begins 500 and proceeds in three steps. Step 1 501 is to first determine if the queue has any messages in it, that is, whether the number of messages is greater than zero. This determination is made by fetching the value of the current producer count PC 220 and consumer count CC 230 from memory and forming the difference NM 255. If the value of NM 255 is positive and not zero, then a producer has received allocation for a place to put a message in the message queue 100 and either the message is ready, or is in the process of being written into the message queue. Step 2 of FIG. 5 502 describes the determination of whether the message is completely written by the producer, with the producer using step 4 in FIG. 4 404 to produce that signal. Entering Step 3 of FIG. 5 it is now known that the entire message record (110 in FIG. 2) is complete, and it is permissible to copy the message to a temporary space 503 and then attempt to officially capture that message from the message queue by atomically incrementing CC 230 the consumer count. If the conditional atomic increment (as diagrammed in FIG. 3) succeeds then the message copied from the message queue is valid and should be processed; otherwise, the message has been already taken by another consumer, and the procedure simply begins again at the top 500 with another try to GET a message. It would also be suitable to simply return a status such as “TRY AGAIN” to the consumer requestor if there were reason for the requestor to need that level of detail in status.

The method of the invention has a distinct advantage over typical methods of the prior art. Prior art methods typically accomplished the prevention of conflict in a message queue by using a single mutex gate word which was referenced and used by all producers or consumer accessing the message queue to ensure that one and only one producer or consumer was accessing the message queue at a time. The mutex was used a “gate” which was either open or closed and any process wanting to manipulate the message queue would have to wait for the gate to be opened, then close the gate in a manner that ensured only one process could close the gate at a time, do the work of manipulating the message queue, and then open the gate. This means that the mutex gate word might be held closed for a significant period of time which is a detriment to performance. Problems could also occur with one process hogging the gate word to the detriment of other processes. The method of the invention overcomes these problems because the increment of both the producer count and the consumer count is a single instruction that must be completed expeditiously by the hardware, so delay is minimal. Also, the actual writing of the message queue is done after the increment of the producer counter so there is no conflict from other processes.

It is noted that the word “increment” as used in describing this invention does not limit the invention to mechanisms which strictly add the value of one to a counter. The concept of incrementing the counter is exemplary and could be replaced by a mechanism which changes a pointer in any manner to move from one record to the next record in a message queue. The key is that the pointers or numbers which locate the record must be unique and also that the pointing mechanism move from one unique record to another in a predictable manner or sequence.

The foregoing description is meant to be illustrative only and not limiting. Other embodiments of this invention will be obvious to those skilled in the art in view of this description. Therefore, the spirit and scope of the appended claims should not be limited to the description of the preferred embodiments contained herein.

What is claimed is:

1. A mechanism for managing communication between multiple parts of a digital hardware system utilizing:
A) a producer count;
B) a consumer count;
C) memory space to hold message records in a message queue used in communication between a plurality of computer system elements;
D) means for conditionally atomically incrementing the producer counter;
E) means for conditionally atomically incrementing the consumer counter;
F) means for limiting the number of records such that the total memory space utilized to hold message records does not exceed the total available memory space; and
G) means used by a producer to signal a potential consumer when an entire message is written completely into the memory space record,
wherein elements of the invention are arranged such that:
the producer count is used to locate the position in the memory space of a message queue where a message is to next be written;
the consumer count is used to locate the position in the memory space of the message queue where the next message is to be retrieved;
a conditional atomic increment of the producer count is performed whenever a message is ready to be delivered and there is first room in the message space for another message record, with the condition on the increment assuring that no other producer of messages has claimed that message record space;
and then after the aforementioned conditional atomic increment of the producer count the producer of that message copies the message data into the message record;
and then after completion of that copying by the producer of the message data into the reserved message record memory space that a final indication is made to any potential consumer that the message is complete within the memory space of that message record;
a conditional atomic increment of the consumer count is performed whenever a message is available in the message queue and the consumer has also ascertained indication that the message was completely posted into the memory space of the message queue, and the message was then completely copied from the message queue so that the message queue record space is no longer needed, with the condition on the atomic increment assuring that only one potential consumer will finally be validated to process the already completely copied message.

2. The mechanism of claim 1 in which element G) is accomplished by storing the producer count itself as the signal mechanism indicating the message is complete.

3. The mechanism of claim 1 in which element G) is accomplished by storing a unique value based upon the producer count itself as the signal mechanism.

4. The mechanism of claim 1 in which all elements of the mechanism are implemented in computer system software.

5. The mechanism of claim 1 in which all elements of the mechanism are implemented in computer system software and the signaling described in element G) of claim 1 is accomplished by storing a unique value based upon the producer count itself as the signal mechanism.
